(19) United States
(12) Patent Application Publication
(10) Pub. No.: US 2003/0212709 A1
(43) Pub. Date: Nov. 13, 2003

(54) Apparatus and method for secure object access

(76) Inventor: Stefaan De Schrijver, Newton, MA (US)

Correspondence Address: LAHIVE & COCKFIELD, 28 STATE STREET, BOSTON, MA, 02109, US

(21) Appl. No.: 10/298,466

(22) Filed: Nov. 18, 2002

Related U.S. Application Data
(63) Continuation of application No. PCT/US01/16227, filed on May 17, 2001.
(60) Provisional application No. 60/205,345, filed on May 18, 2000.

(51) Int. Cl. G06F 7/00

(52) U.S. Cl. 707/104.1

(57) ABSTRACT

A method and apparatus to use biometric data to secure an object connected to a computer. The object maintains connections to one or more computers, and similarly to a biometric database that includes biometric data for computer users. Object requests from computers can be coupled with biometric data from a plurality of computer users. The biometric data can be entered on a periodic basis as scheduled by a security manager. Peripheral requests including biometric data can be subjected to a two-step analysis. First, the biometric data can be matched against the biometric database to ensure a match. If a match is not found, the request can be denied. If a match is found, the second analysis step includes determining whether the verified user has privilege for the requested object access. Multiple objects connected to multiple computers is anticipated, and the two-step analysis can be combined into a single step by providing a biometric database that includes only authorized user information. A single biometric database can be used for all peripherals, or multiple biometric databases can exist for multiple peripherals. The objects can be peripheral devices of any kind, they also can be smartcards, tokens or electronic cartridges. The peripheral devices can be inserted or removed from computer networks, computers, workstations, PDA's, other peripheral devices such as printers or storage drives, handheld devices or other computerized instruments.

### RELATED INFORMATION

The present application is a continuation of PCT patent application number PCT/US01/16227, filed on May 17, 2001, which claims priority to U.S. provisional patent application No. 60/205,345, filed on May 18, 2000, the entire contents both of which are hereby incorporated by reference.

### BACKGROUND OF THE INVENTION

(1) Field of the Invention

The present invention relates generally to accessing objects such as data files, executable files, computer code, embedded code, or drivers for peripheral devices attached to a network or to a computer. More particularly it relates to an apparatus and method to allow select users to access specified objects.

(2) Description of the Prior Art

The rapid increase in personal computer (PC) use and internet access poses security problems for those wishing to secure a device, database, etc. that is connected to a network. The security problem can be viewed as an access problem, wherein those attempting to preserve a secure device desire to allow access to that device by known, certified users, or desire to only allow execution of known objects, or desire to protect the content of a file from un-authorized viewing, listening or reading.

The allowable users may be connected through a local connection, a cable, an internal network, or an external network including the internet. The connection can be made possible in wired, wireless, or contact-less mode. Identifying and correctly certifying users in a reliable manner is therefore necessary to any secure apparatus or methodology.

Peripherals include devices that are distinct from the central processing unit, and provide systems with additional capabilities. They are often, but not necessarily, externally connected to a computing device, and include traditional devices such as printers, disk drives (hard, floppy, magnetic, optical, memory sticks, flash cards, smartcards, PCMCIA-cards etc.), monitors, keyboards, etc. The definition of computing device, however, is expanding, and comprises cellular telephones, personal digital assistants, embedded processors, etc.

Often, system or network managers wish to limit user access to certain peripheral devices, with the most common examples including restricted access to particular printers or specific storage devices. A prior art system presents an apparatus for locking auxiliary devices in portable computers. Other prior art systems provide means to secure peripherals using locks, bolts, and other securing hardware to prevent theft. None of the aforementioned patents provide a means to restrict user access when the device is connected to internal or external networks. Alternately, another prior art system permits access to secured computer resources using a system password that is derived from a plain text password and an external encryption algorithm. Unfortunately, plain text passwords and smartcards can be stolen, thereby causing a security problem.

There is currently no method or apparatus that restricts object usage or peripheral device usage using access rights and privileges that are biometrically connected to the user. The concept of “user” is also expanding and is no longer limited to a human, but can include “software agents”. Thus in the context of the present invention “user” includes humans and software agents directly or indirectly, biometrically or by other means, linkable to humans.

What is needed is an apparatus and method that allows an owner, or a system or network manager to restrict or enable users from accessing peripherals based the recognition of the individual by means of biometric data.

### SUMMARY OF THE INVENTION

The present disclosure provides an apparatus and method whereby access to computer peripheral devices is restricted by biometric data that is provided to the peripheral. If the biometric data appropriately matches biometric data stored in a database, access to the peripheral can be granted.

The database can consist of a single template for a single user and be stored on the peripheral device. For example a biometric template can be stored in the memory of an electronic pen that contains certain private secure information regarding the owner of the pen. This private secure information can only be accessed by other objects in the application system, for instance health care, if indeed the user of the pen is the registered owner of the pen, as authenticated through verification of the biometric template in the pen.

The database may consist of multiple templates per user, of various biometric means, such as voice, fingerprint, iris-scan, etc. The database may consist of multiple users on a centralized storage means, or it may be distributed and replicated over multiple heterogeneous or homogeneous storage means interconnected through a network, as known in the art of database management.

The peripheral devices may include memory devices, printers, cellular phones, personal digital assistants, and any other device that can be connected to a computer either directly, or remotely, such as through a network. Such connections may be wired, wireless or contactless.

Other objectives and advantages of the present invention will become more obvious hereinafter in the specification and drawings.

These objectives are accomplished with the present invention by a method and apparatus to use biometric data to secure an object or a peripheral device connected to a computer. The peripheral device can maintain connections to one or more computers, and similarly to a biometric database that includes biometric data for computer users. Access requests to objects from computing devices can be coupled with biometric data from computer users. The biometric data can be entered on a periodic basis as scheduled by the security manager. Access requests to objects not including such biometric data can be immediately denied. Access requests to objects including biometric data can be subjected to a two-step analysis. First, the biometric data can be matched against the biometric database to ensure a match. If a match is not found, the request can be denied. If a match is found, the second analysis step can include determining whether the verified user has privilege for the requested peripheral. Multiple objects connected to multiple computing devices are anticipated, and the two-step analysis can be combined into a single step by providing a biometric database that includes only authorized user information. A single biometric database can be used for all objects, or multiple biometric databases can exist for a single or for multiple objects.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings, wherein like reference numerals refer to like parts and wherein:

FIG. 1 presents an exemplary architectural block diagram of one illustrative system that practices the invention disclosed herein wherein the object is a computer peripheral device, more specifically a printer; and,

FIG. 2 presents an illustrative functional block diagram representing the verification process for a system according to FIG. 1.

### DESCRIPTION OF THE ILLUSTRATED EMBODIMENTS

To provide an overall understanding of the invention, certain illustrative embodiments will now be described; however, it will be understood by one of ordinary skill in the art that the systems described herein can be adapted and modified to provide systems for other suitable applications and that other additions and modifications can be made to the invention without departing from the scope hereof.

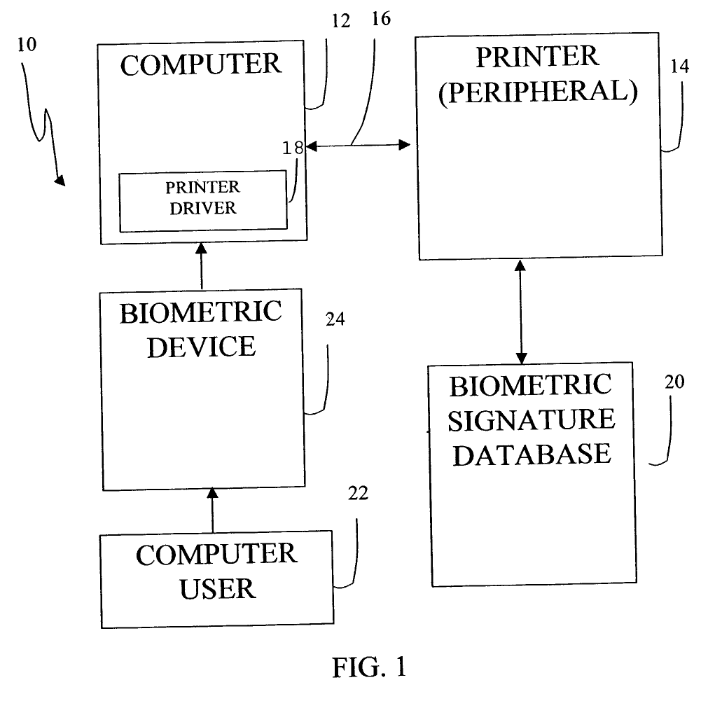

Referring now to FIG. 1, there is shown a configuration 10 wherein a computer 12 is connected to a peripheral device that is depicted in FIG. 1 as a printer 14. As is known in the art, the computer 12 can be any micro-processor device that is included in a computer workstation, such as a PC workstation or a SUN™ workstation, handheld, laptop, palmtop, personal digital assistant, telephone, smartcard, controller, etc., that comprises a program for organizing and controlling the microprocessor-based system to operate according to the invention as described herein. The microprocessor system can access information sources that are accessible via a communication network, keyboard, digital camera, microphone, etc. Additionally and optionally, the microprocessor-based system can be equipped for processing multimedia data, and can be, for example, a conventional PC computer system with a sound and video card. The computer system can operate as a stand-alone system or as part of a networked computer system. Alternatively, the computer system can be a dedicated device, such as an embedded system, that can be incorporated into existing hardware devices, such as telephone systems, PBX systems, sound cards, facsimile devices, scanners, printers, etc. Accordingly, it will be understood by one of ordinary skill in the art that the systems and methods described herein have wide applicability and can be incorporated in many systems, and realized in many forms, all without departing from the scope of the invention.

For the purposes of this invention, a peripheral is any device that is distinct from the computer 12 central processing unit, and provides the “computer” 12 system with additional functionality and/or capabilities. Examples peripherals can include a hard drive, floppy drive, optical drive, printer, keyboard, mouse, cellular phone, personal digital assistant, memory card, memory stick etc., although such a list is not intended to be exhaustive or limiting, but merely illustrative. The connection between the peripheral device and computer can be wired, wireless or contactless, and can be through a network such as the internet, noting herein that the present invention is not limited to the connection between the computer and the peripheral device. As indicated herein, the computer 12 can be a personal computer, SUN™ workstation, handheld computer, or any other microprocessor-based device capable of connecting to an object such as a printer. Similarly, although FIG. 1 depicts a printer as the object, the invention herein is not so limited, and includes other objects for which access can or might be restricted, with the most common, traditional restricted-access devices including disk drives and other storage media.

The illustrated computer 12 accesses the printer 14 through an interface 16 that can be wired, wireless or contactless. Additionally, although only a single computer 12 is shown in the illustrative block diagram of FIG. 1, the present invention can encompass a multiple computer scenario, wherein multiple computers can be connected to a peripheral device. Similarly, multiple peripherals can be connected to multiple computers. In this specification, it shall therefore be understood that references to “the computer” includes references to multiple computers, and likewise, references to “the printer” includes references to any one or more peripheral devices connected to one or more of the multiple computers, for which limited or restricted access can be desired.

The FIG. 1 computer 12 includes a printer driver 18 that allows the computer to communicate with the printer 14. Alternately, the printer driver 18 can access a biometric signature database 20. The FIG. 1 biometric signature database 20 includes biometric data for computer users. The biometric database 20 can be stored internally or externally to the printer 14, and if the biometric database 20 is stored external to the printer 14, the connection between the two devices can be wired, wireless or contactless. The printer driver 18 can include software to access the biometric database 20 and retrieve information determining whether a specified user has access to the printer or to the files or the specified file to be printed on the printer 14. A separate biometric database 20 can be maintained for a given object (a print file), or a single biometric database can be accessible to multiple objects (print queue).

The computer 12 can also include an application programmer interface (API) to allow users to be notified, through a print manager, of the printer status and printer availability based upon the biometric data.

For the system of FIG. 1, the computer user 22 can enter biometric data to the computer through a biometric device 24 such as the LCI-SMARTpen®, although the invention is not so limited to such device, and any device capable of recording and translating biometric data to the computer 12 is acceptable. Other examples of biometric data include fingerprint data and human eye retinal data. In the case of the LCI-SMARTpen®, the pen records various biometric processes of the user related to the user's signature, including but not limited to, the writing speed, the pressure exerted upon the pen, and signature flow. The biometric data can be received by the computer 12, and the printer driver 18 attaches the biometric data to print requests for the current user login session. The printer 14 can then access the biometric database 20 to first verify the biometric data attached to the print request, and to secondly verify that the user has the correct privilege for the printer 14. The user can be informed of a failed print request through the print manager API if the biometric data is not attached to the print request, if the biometric data entered by the user does not match the biometric database 20, or if the user is not authorized to use the printer 14 even though the biometric data matches the biometric database 20.

In an embodiment, the biometric data attached to the print request can be updated each login session, or for each print request, depending upon system architecture and security goals. A system manager or administrator can therefore establish the policy rules requiring the submission and subsequent updating of biometric data.

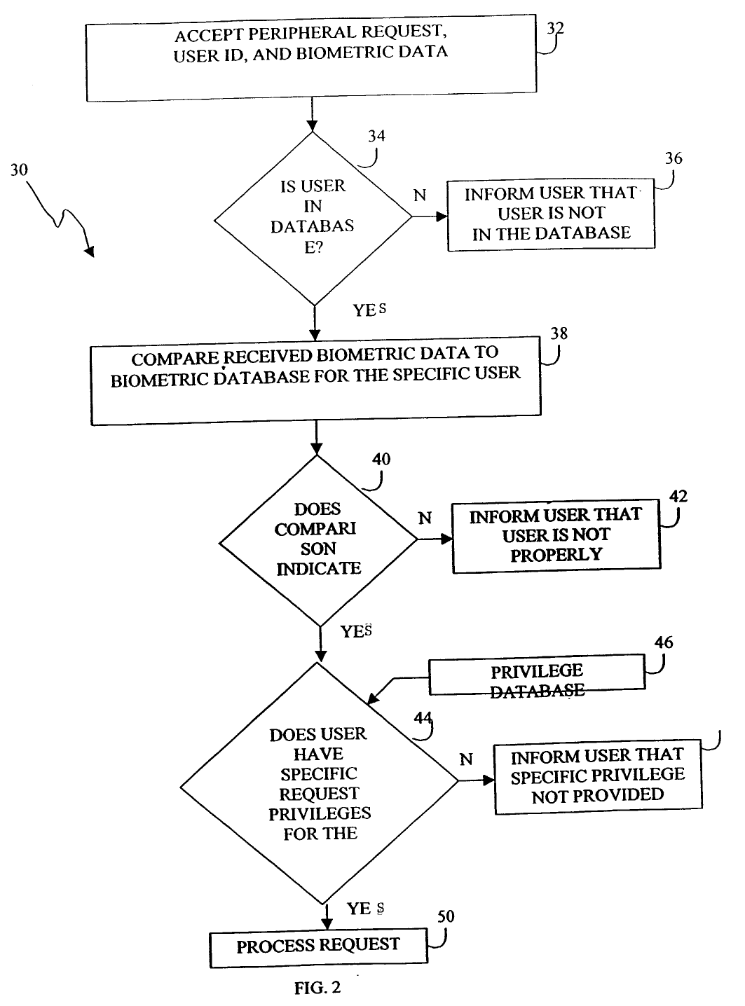

Referring now to FIG. 2, there is an illustrative functional block diagram 30 of the logic for validating a request for access to an object. The illustrated object can receive a request with the associated user identification (ID) and biometric data 32. First, the object can verify that the user maintains a biometric database profile 34, and if such a profile does not exist for this user, the request can be denied and the user can be informed that a database entry does not exist 36. Alternately, if the user maintains a database entry, the database entry corresponding to that user can be compared to the received biometric data 38. If the comparison 40 does not substantiate the user identity, the user can be informed that the biometric information is not valid 42, and the request for access to the object is denied. Alternately, if the biometric information is validated by the database information, it can be determined whether the user is authorized with the requested privileges for this specific object 44. Referring to FIG. 2, a privilege database 46 can be utilized to store and subsequently access the various user privileges for different peripheral devices, although the invention herein is not limited to using a database and the invention allows for alternate embodiments wherein the privilege data is stored in unstructured memory. Depending upon the object and the application, the logic presented in 44 can actually require two sub-components. The first sub-component can determine whether the user is privileged to make requests for the specified peripheral device, while the second sub-component can determine whether the user has the specific privileges presented by the request. For example, a user can have read privileges to a memory device, but not write privileges to that same device. In one embodiment, if either of the sub-component analyses produce a negative result, the user can be informed that the object privileges do not exist 48. Alternately, if both sub-component analyses produce a positive result, the request can be processed 50.

As an example of a possible embodiment, a virus is introduced in a computer system by an unsuspected user. The computer system requires that objects cannot obtain privileges to be executed by the software agent unless the biometrics of the user and of the system manager match. However the virus, introduced by the user, has only has the user ID, and, maybe, the user's biometrics, but not the system manager's biometrics to which the user-id has no access privilege, and thus the virus cannot be executed, and does cannot damage the system.

As yet another illustration of a possible embodiment, a streaming digital music file can only be played by an MP3 player if the music file is authenticated by matching the biometrics of the buyer of the file with the biometrics of the owner of the MP3 player and by the biometrics of the seller. The biometric templates are transferred to the MP3 player by means of a secure buyer certificate, as known in the art of public key infrastructures, electronic signatures and asymmetric encryption.

As another embodiment of the present invention, the peripheral device may have the form of a removable card, cartridge or token that can execute specific electronic functions such as MP3 player or storage, and that is inserted in the writing instrument. Execution of the function can only occur after the computer has biometrically verified the user and decided that the user is entitled to use the card, token or cartridge.

One advantage of the present invention over the prior art is that the present invention provides an apparatus and method to securely access objects using biometric data. The invention is not limited to devices but applies to any object, hardware or software, used in a system. The invention extends the meaning of “user” from a physical person to a logical entity, including software drivers for controllers of devices, or even software agents. Thus the invention extends biometric access control to all objects present in an environment that uses computing devices. As a result, a user can only have access to a biometrically annotated object if the access request contains instances of biometrics that match the biometric templates referred to in the object annotation.

What has thus been described is a method and apparatus to use biometric data to secure an object used in a computer. The object can maintain connections to one or more computers, and similarly to a biometric database that includes biometric data for computer users. Object access requests from computers can be coupled with biometric data from computer users. The biometric data can be entered on a periodic basis as scheduled by the security manager. Object access requests not including such biometric data can be immediately denied. Object access requests including biometric data can be subjected to a two-step analysis. First, the biometric data can be matched against the biometric database to ensure a match. If a match is not found, the request can be denied. If a match is found, the second analysis step can include determining whether the verified user has privilege for the requested peripheral. Multiple objects connected to multiple computers are anticipated, and the two-step analysis can be combined into a single step by providing a biometric database that includes only authorized user information. A single biometric database can be used for all objects, or multiple biometric databases can exist for multiple objects. Thus an object may only be accessed when it is properly recognized (identified and authenticated) by biometric means and when the user has the appropriate access privileges. As described the apparatus and method of this invention can protect computer environments against viruses, can deny printing of files by unintended recipients, or can protect streaming video or audio files against playing by unauthorized users.

Although the present invention has been described relative to a specific embodiment thereof, it is not so limited. Obviously many modifications and variations of the present invention may become apparent in light of the above teachings. For example, although a printer was utilized as the object, other objects may be used. Many processing steps may be separated or otherwise combined without departing from the scope of the invention. The communications links between devices and databases may be wired, wireless or contactless. The databases may be replaced with other memory modules. The biometric signals may be of any type.

Many additional changes in the details, materials, steps and arrangement of parts, herein described and illustrated to explain the nature of the invention, may be made by those skilled in the art within the principle and scope of the invention. Accordingly, it will be understood that the invention is not to be limited to the embodiments disclosed herein, may be practiced otherwise than specifically described, and is to be understood from the following claims, that are to be interpreted as broadly as allowed under the law.

I claim:

1. An apparatus for securing an object, comprising:
a micro-processor based device to submit requests to the object;
a biometric database connected to the object;
a verification module to validate the requests against the biometric database.

2. The apparatus of claim 1, further comprising:
a biometric device to collect biometric data; and
a module to couple biometric data with the object request.

3. The apparatus of claim 2, wherein the biometric device comprises a writing implement to record biometric data during a signature event.

4. The apparatus of claim 2, wherein the biometric data is selected from the group consisting of a fingerprint, human retinal information, human voice information, and human facial information.

5. The apparatus of claim 1, wherein the micro-processor based device is a personal computer.

6. The apparatus of claim 1, wherein the micro-processor based device is a workstation.

7. The apparatus of claim 1, wherein the micro-processor based device is a handheld electronic device.

8. The apparatus of claim 1, wherein the micro-processor based device is embedded in another electronic device.

9. The apparatus of claim 1, wherein the micro-processor based device is a removable and exchangeable insert in another electronic device.

10. The apparatus of claim 1, wherein the object is a printer.

11. The apparatus of claim 1, wherein the object is a storage medium.

12. The apparatus of claim 1, wherein the object is a telephone.

13. The apparatus of claim 1, wherein the object is a personal digital assistant.

14. The apparatus of claim 1, wherein the object is a DVD player.

15. The apparatus of claim 1, wherein the object is a MP3 player.

16. The apparatus of claim 1, wherein the object is an software agent.

17. The apparatus of claim 1, wherein the object is a data file.

18. The apparatus of claim 1, wherein the object is an executable software file.

19. A method of securing a object, comprising:
establishing a biometric database;
transmitting a request from a micro-processor based device to the object; and
validating the requests against the biometric database.

20. The method of claim 19, further comprising:
collecting biometric data using a biometric device; and
coupling biometric data with the object request.

21. The method of claim 20, wherein collecting biometric data comprises recording biometric data from a writing implement during a signature event.

22. The method of claim 20, wherein collecting biometric data comprises accepting a fingerprint.

23. The method of claim 20, wherein collecting biometric data comprises obtaining human retinal information.

24. The method of claim 19, wherein validating the requests against the biometric database further comprises:
associating a user with the request;
ensuring there is user-specific biometric data in the biometric database; and
ensuring there is user-specific biometric data associated with the object; and
granting the request only upon verifying the user-specific biometric data against the request, and ensuring there are object-specific privileges for the user.

25. The method of claim 19, further comprising developing an object-specific database to store user privileges for the object.

26. The method of claim 24, wherein ensuring there are object-specific privileges for the user further comprises:
developing an object-specific database to store user privileges for the object; and
verifying the user maintains privileges for the object.

27. The method of claim 26, further comprising requiring that the user maintains privileges consistent with the request.

28. The method of claim 19, further comprising:
processing only properly validated requests; and
producing a message for the micro-processor based device when requests are not properly validated.

29. The method of claim 19 whereby the user is not a human but an executable code object associated with a human through biometric means and through privileges.
